(19) United States
(12) Patent Application Publication
(10) Pub. No.: US 2022/0312994 A1
(43) Pub. Date: Oct. 6, 2022

(54) THERMAL INSULATION CUP WITH A TILTED NECK

(71) Applicant: ZHURONG FU, Ningbo (CN)

(72) Inventor: ZHURONG FU, Ningbo (CN)

(21) Appl. No.: 17/348,198

(22) Filed: Jun. 15, 2021

(30) Foreign Application Priority Data
Apr. 1, 2021 (CN) 202120673944.0

(51) Int. Cl. A47G 19/22; B65D 81/38

(52) U.S. Cl. CPC A47G 19/2288; B65D 81/3869; A47G 19/2266

(57) ABSTRACT

A thermal insulation cup with a tilted neck includes an outer case and an inner tank arranged inside the outer case. The outer case includes a first cup wall, a second cup wall, and a case bottom that together define a cavity with an open end. The end of the first cup wall has a less height than that of the end of the second cup wall. The first cup wall gradually tilts inward in the direction from the bottom to the end. The second cup wall gradually tilts inward in the direction from the bottom to the end. The inner tank includes a drinking port, a first inner wall, a second inner wall, and a bottom that together define a cavity with an open end. The end of the first inner wall has a less height than that of the second inner wall. The first inner wall gradually tilts inward in the direction from the bottom to the end, and the second inner wall gradually tilts inward in the direction from the bottom to the end. The ends of the outer case and the inner tank respectively define an opening and a drinking port that are inclined to the same side. The opening is welded and fixed to the lower part of the drinking port.

### CROSS-REFERENCE TO RELATED APPLICATIONS

This application claims the priority to and benefit of Chinese patent application number 202120673944.0, entitled “THERMAL INSULATION CUP WITH A TILTED NECK”, and filed on Apr. 1, 2021 with China National Intellectual Property Administration, the entire contents of which are incorporated herein by reference in its entirety.

### TECHNICAL FIELD

This disclosure relates to a thermal insulation cup, and more particularly relates to a thermal insulation cup with a tilted neck.

### BACKGROUND

At present, there are many kinds of thermal insulation cups available on the market, with various different designs. However, the tops of these thermal insulation cups have long had a horizontal design, which cannot meet the individual needs of users.

### SUMMARY

In order to solve the above technical problems, this disclosure provides a thermal insulation cup with a tilted neck.

The thermal insulation cup includes an outer case and an inner tank arranged inside the outer case.

The outer case is composed of a first cup wall, a second cup wall, and a case bottom which together define a cavity with an open end. The end of the first cup wall has a less height than that of the end of the second cup wall. The first cup wall gradually tilts inward in the direction from the bottom to the end. The second cup wall gradually tilts inward in the direction from the bottom to the end. The inner tank includes a drinking port, a first inner wall, a second inner wall, and a bottom that together enclose a cavity with an open end. The end of the first inner wall has a less height than that of the second inner wall. The first inner wall gradually tilts inward in the direction from the bottom to the end, and the second inner wall gradually tilts inward in the direction from the bottom to the end.

A thread is disposed on the outside of the drinking port.

The opening of the outer case and the drinking port of the inner tank are inclined in the same orientation.

The inner tank is sleeved inside the outer case, and the opening and the drinking port are fixed by welding.

Compared with the prior art, this disclosure has the following beneficial effects. The tilted neck thermal insulation cup of the present disclosure has a reasonable structural design, where the ends of the outer case and the inner tank respectively define an opening and a drinking port that are inclined to the same side. The opening is welded and fixed to the lower part of the drinking port. Thus, the side-inclined drinking port is convenient for drinking, has a more personalized design, is easy to use, and can meet the individual needs of users.

### BRIEF DESCRIPTION OF DRAWINGS

FIG. 1is a schematic cross-sectional view of an embodiment of a thermal insulation cup with a tilted neck according to the present application.

FIG. 2 is a schematic diagram of a cross-sectional structure of the outer case of an embodiment of the bent-neck thermal insulation cup according to the present application.

FIG. 3 is a schematic cross-sectional view of the inner tank of an embodiment of a thermal insulation cup with a tilted neck according to the present application.

FIG. 4 is an enlarged schematic diagram of the drinking port structure of an embodiment of the bent-neck thermal insulation cup according to the present application.

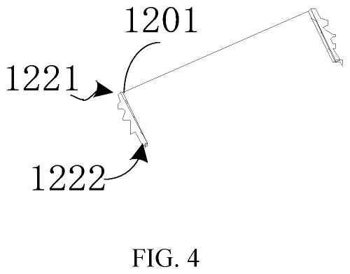

### DETAILED DESCRIPTION OF EMBODIMENTS

Hereinafter, technical solutions in the embodiments according to the present application will be described in a definite and comprehensive manner in connection with the accompanying drawings in the embodiments according to the application disclosure. Apparently, the embodiments described herein are only a part, rather than all of the embodiments in accordance with the present application. Based on the embodiments of the present application, all other embodiments obtained by those having ordinary skill in the art without investing creative efforts shall all fall in the scope of protection of the present application.

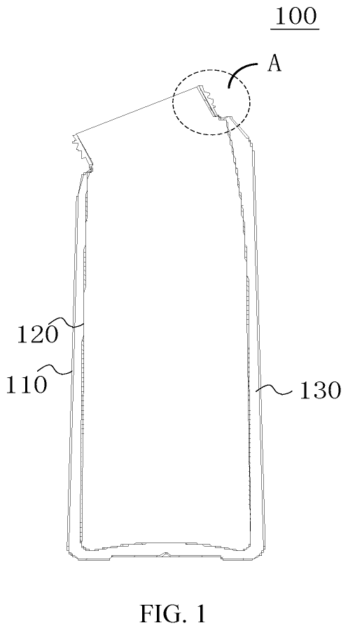

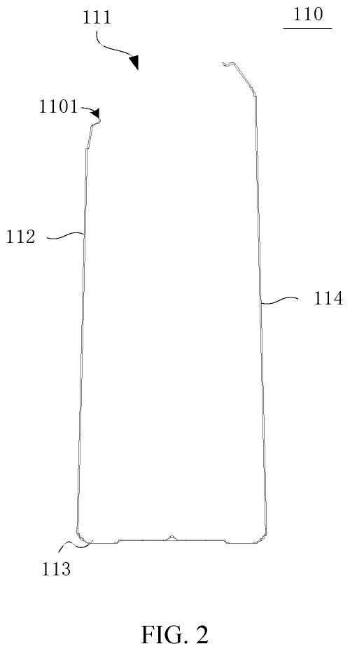

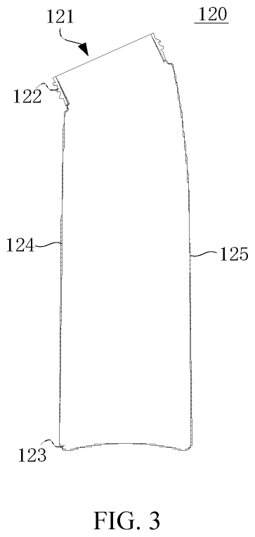

As illustrated in FIGS. 1-3, there is shown a bent-neck thermal insulation cup 100 that includes an outer case 110 and an inner tank 120 arranged inside the outer case 110. The outer case 110 is composed of a first cup wall 112, a second cup wall 114, and a case bottom 113 which jointly define a cavity with an end opening 111. The height of the end of the first cup wall 112 is less than the height of the end of the second cup wall 114. The first cup wall 112 gradually tilts inward in the direction from the bottom to the end, and the second cup wall 114 gradually tilts inward in the direction from the bottom to the end. It will be appreciated that the cavity with the upper open end that is surrounded by the first cup wall 112, the second cup wall 114, and the case bottom 113 may be cylindrical in shape, where the first cup wall 112 and the second cup wall 114 are reference surfaces of the same columnar body, and the first cup wall 112 and the second cup wall 114 have a height difference so that the upper end opening can be inclined.

The bottom 113 of the outer case is convex in a downward direction on the circumference, and concave inwards in the middle, so that the cup body is not easy to tip over when placed on a different rough table top.

The inner tank 120 includes a drinking port 121, a first inner wall 124, a second inner wall 125, and a bottom 123, which jointly define a cavity with an open end. It will be appreciated that the end opening is also the opening of the drinking port 121, the height of the end of the first inner wall 124 is smaller than the height of the second inner wall 125, the first inner wall 124 gradually tilts inward in the direction from the bottom to the end, and the second inner wall 125 gradually tilts inward in the direction from the bottom to the end. It will be appreciated that the first inner wall 124 and the second inner wall 125 are both inclined to the inside, similar to a trapezoid shape, so that the opening of the drinking port 121 has a smaller size than that of the bottom 123 of the inner tank.

A threaded portion 122 is arranged on the outside of the drinking port 121 for fixing a cup lid (not shown in the figures).

The opening 111 of the outer case 110 and the drinking port 121 of the inner tank 120 are inclined in the same orientation, that is, the first cup wall 112, the second cup wall 114, the first inner wall 124, and the second inner wall 125 are all inclined in the same direction, and all are gradually inclined to the inside in the direction from the bottom to the end.

The inner tank 120 is arranged inside the outer case 110, and the upper edge 1221 of the threaded portion 122 is welded to the upper opening 1201 of the inner tank, the lower edge 1222 of the threaded portion 122 is welded to the upper edge 1101 of the outer case, and a hollow is defined between the threaded portion 122 and the inner tank 120, so that a hollow partition 130 is formed between the outer case 110 and the inner tank 120.

The tilted neck thermal insulation cup of the present disclosure has a reasonable structural design, where the ends of the outer case and the inner tank respectively define an opening and a drinking port that are inclined to the same side. The opening is welded and fixed to the lower part of the drinking port. Thus, the side-inclined drinking port is convenient for drinking, has a more personalized design, is easy to use, and can meet the individual needs of users.

The foregoing merely depicts some illustrative embodiments of the present application, which are not intended to limit the scope of the present disclosure in any means. Any equivalent structural to process changes made on the basis of the contents of the description and drawings of the present disclosure, or any direct or indirect use of the present disclosure on other related technical fields shall all be included in the scope of protection of the present disclosure.

What is claimed is:

1. A thermal insulation cup with a tilted neck, comprising:
an outer case; and
an inner tank, arranged inside the outer case;
wherein the outer case comprises a first cup wall, a second cup wall, and a case bottom which together define a cavity with an open end, wherein an end of the first cup wall has a less height than that of an end of the second cup wall, wherein the first cup wall gradually tilts inward in the direction from the case bottom to the end, and the second cup wall gradually tilts inward in the direction from the case bottom to the end;
wherein the inner tank comprises a drinking port, a first inner wall, a second inner wall, and a bottom that together define a cavity with an open end; wherein an end of the first inner wall has a less height than that of the second inner wall, wherein the first inner wall gradually tilts inward in the direction from the bottom to the end, and the second inner wall gradually tilts inward in the direction from the bottom to the end.

2. The thermal insulation cup of claim 1, wherein a threaded portion is disposed on an outer side of the drinking port.

3. The thermal insulation cup of claim 1, wherein the opening of the outer case and the drinking port of the inner tank are inclined in a same orientation.

4. The thermal insulation of claim 2, wherein the inner tank is disposed inside the outer case, an upper edge of the threaded portion outside the drinking port is welded to an upper edge of the inner tank, and a lower edge of the threaded portion is welded to an upper edge of the outer case, and wherein a hollow defined between the threaded portion and the drinking port of the inner tank is in communication with a hollow between the inner tank and the outer case.
